(19) United States
(12) Patent Application Publication
(10) Pub. No.: US 2025/0111215 A1
(43) Pub. Date: Apr. 3, 2025

(54) CONFIGURABLE COMPUTING-IN-MEMORY (CIM) FOR POWER CONTROL

(71) Applicant: MEDIATEK INC., Hsinchu (TW)

(72) Inventors: Chieh-Fang TENG, Hsinchu (TW); En-Jui CHANG, Hsinchu (TW); Chih Chung CHENG, Hsinchu (TW)

(73) Assignee: MEDIATEK INC., Hsinchu (TW)

(21) Appl. No.: 18/476,882

(22) Filed: Sep. 28, 2023

(51) Int. Cl. G06N 3/063

(52) U.S. Cl. CPC G06N 3/063

(57) ABSTRACT

A method can include determining which computing units in a computing-in-memory (CIM) macro are to be turned off, the CIM macro including an array of the computing units with X rows and Y columns, the X rows of computing units being organized into N row-groups, each row-group including multiple rows of computing units, the Y columns of computing units being organized into M column-groups, each column-group including multiple columns of computing units, based on the determination of which computing units in the CIM macro are to be turned off, turning off at least one row-group or column-group of computing units, each row-group and column-group of computing units being separately controllable to be turned off, and performing a computation based on kernel weights and activations of a neural network stored in the active computing units in the CIM macro that are not turned off.

### TECHNICAL FIELD

The present disclosure relates to computing-in-memory techniques.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In-memory computing technology can be used in a neural network to reduce data movement between storage units and processing units. In-memory computing technology can store the weights of inputs in memory and perform the neural network computation directly in the memory to improve the efficiency of the system.

### SUMMARY

Aspects of the disclosure provide a method. The method can include determining which computing units in a computing-in-memory (CIM) macro are to be turned off, the CIM macro including an array of the computing units with dimensions of X rows and Y columns, the X rows of computing units being organized into N row-groups indexed from 0 to N−1, each row-group including one or more rows of computing units, the Y columns of computing units being organized into M column-groups indexed from 0 to M−1, each column-group including one or more columns of computing units, based on the determination of which computing units in the CIM macro are to be turned off, turning off at least one row-group of computing units or at least one column-group of computing units, each row-group of computing units being separately controllable to be turned off, each column-group of computing units being separately controllable to be turned off, and performing a computation based on kernel weights and activations of a neural network stored in the active computing units in the CIM macro that are not turned off.

In an embodiment, the determining which computing units in the CIM macro are to be turned off includes determining a number of output channels (OCs) in a layer of the neural network, determining a number of kernel weights corresponding to each OC, the kernel weights corresponding to each OC being to be mapped to a respective one of the Y columns of computing units, in response to the number of OCs being smaller than Y, determining to turn off the column-groups of computing units to which no kernel weights are to be mapped, and in response to the number of kernel weights corresponding to each OC being smaller than X, determining to turn off the row-groups of computing units to which no kernel weights are to be mapped.

In an embodiment, the determining which computing units in the CIM macro are to be turned off includes determining a number of OCs in a layer of the neural network, determining a number of kernel weights corresponding to each OC, the kernel weights corresponding to each OC being to be mapped to a respective one of the Y columns of computing units, in response to the number of OCs being larger than Y, determining to turn off the column-groups of computing units to which no kernel weights are to be mapped during sequential computing cycles, and in response to the number of kernel weights corresponding to each OC being larger than X, determining to turn off the row-groups of computing units to which no kernel weights are to be mapped during sequential computing cycles.

In an embodiment, the determining which computing units in the CIM macro are to be turned off includes determining a number of OCs in a layer of the neural network, determining a number of kernel weights corresponding to each OC, the kernel weights corresponding to each OC being to be mapped to a respective one of the Y columns of computing units, in response to the number of OCs wherein all kernel weights in one OC being zero, determining to turn off the column-groups of computing units to which the kernel weights are to be mapped during sequential computing cycles, and in response to the kernel weights corresponding to each OC being zero, determining to turn off the row-groups of computing units to which no kernel weights are to be mapped.

In an embodiment, the determining which computing units in the CIM macro are to be turned off includes receiving a number of activations shared by a number of output channels (OCs) in a layer of the neural network, the activations shared by the OCs being to be mapped to respective ones of the Y columns of computing units, among the number of activations shared by the number of OCs, determining the activations corresponding to the at least one row-group of computing units being zero, and determining to turn off the at least one row-group of computing units.

In an embodiment, the method can further include latching first activations to a first row-group of computing units at time t for a first neural network operation, determining whether second activations to be latched to the first row-group of computing units at time t+1 for a second neural network operation are the same as the first activations, and in response the second activations to be latched to the first row-group of computing units at time t+1 for the second neural network operation are the same as the first activations, determining not to re-latch the second activations to the first row-group of computing units.

In an embodiment, the determining which computing units in the CIM macro are to be turned off includes receiving a number of activations shared by a number of OCs in a layer of the neural network, the activations shared by the OCs being to be mapped to respective ones of the Y columns of computing units and each including first bit position and second bit position neighboring each other, performing first multiplications based on first bit values corresponding to the first bit positions of the activations shared by the OCs in the array of the computing units, determining, corresponding to the at least one row-group of computing units, second bit values corresponding to the second bit positions and the first bit values corresponding to the first bit positions of the activations being the same, and in response to, corresponding to the at least one row-group of computing units, second bit values corresponding to the second bit positions and the first bit values corresponding to the first bit positions of the activations being the same, determining to turn off the at least one row-group of computing units for performing second multiplications based on the second bit values corresponding to the second bit positions of the activations shared by the OCs in the array of the computing units.

In an embodiment, the performing a computation based on kernel weights and activations of a neural network stored in the active computing units in the CIM macro that are not turned off includes dividing a long bit-width activation into smaller bit-width activations, dividing a long bit-width kernel weight into smaller bit-width kernel weights, in response to compute with lower bit-width activations, determining to turn off input buffers for the higher bit-width kernel weights, and in response to compute with higher bit-width activations, determining to turn off input buffers for the higher bit-width kernel weights.

Aspects of the disclosure provide an apparatus. The apparatus includes circuitry configured to determine which computing units in the CIM macro are to be turned off, the CIM macro including an array of the computing units with dimensions of X rows and Y columns, the X rows of computing units being organized into N row-groups indexed from 0 to N−1, each row-group including one or more rows of computing units, the Y columns of computing units being organized into M column-groups indexed from 0 to M−1, each column-group including one or more columns of computing units, based on the determination of which computing units in the CIM macro are to be turned off, turn off at least one row-group of computing units or at least one column-group of computing units, each row-group of computing units being separately controllable to be turned off, each column-group of computing units being separately controllable to be turned off, and perform a computation based on kernel weights and activations of a neural network stored in the active computing units in the CIM macro that are not turned off.

Aspects of the disclosure provide a non-transitory computer-readable medium storing instructions. The instructions, when executed by a processor, cause the processor to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1A shows an example of conventional computing architecture 100;

FIG. 1B shows an example of computing-in-memory (CIM) architecture 104;

FIG. 2 shows an example of kernel weights 201 mapping onto CIM macro 202;

FIG. 3 shows an example of dividing a CIM macro 301 into smaller groups;

FIG. 4 shows a processing system 400 according to some embodiments of the disclosure;

FIG. 5 shows an example of determining control signals based on a weight size of an input data 501 and a dimension of a CIM macro 521;

FIG. 6 shows an example of determining control signals based on a weight size of an input data 601 and a dimension of a CIM macro 621;

FIG. 7 shows an example of determining control signals based on a weight size of an input data 701 and a dimension of a CIM macro 721 in conjunction with pruning techniques;

FIG. 8A-8B show an example of determining control signals based on an activation value of input data activations;

FIG. 9A-9B show an example of determining control signals based on a change in the activation value of input data activations;

FIG. 10A-10B show an example of determining control signals based on an activation value of input data activations during serial execution of a neural network;

FIG. 11 shows an example of multiplication between an 8-bit activation and an 8-bit kernel weight;

FIG. 12 shows a process 1200 of the configurable CIM macro according to an embodiment of the disclosure; and

FIG. 13 shows an example of configuring a CIM macro 1300 to save power.

### DETAILED DESCRIPTION OF EMBODIMENTS

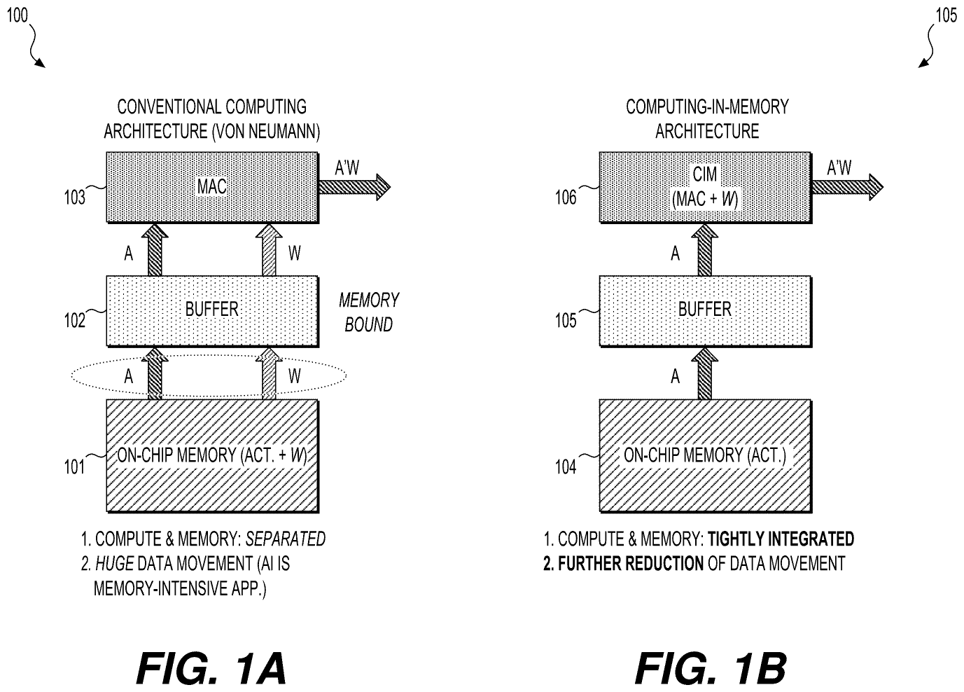

FIG. 1A illustrates a conventional computing architecture 100 known as Von Neumann architecture. In the context of a neural network, the activation and the kernel weights are stored in the on-chip memory 101. The activations and the kernel weights are moved to the multiplier-accumulator (MAC) unit 103 for computation via some buffers 102. Due to the increase in computation complexity of neural networks, a large amount of the data being moved between the on-chip memory 101 and the MAC unit 103 significantly reduces the computation efficiency of the Neural Network system. In-memory computing technology that emerged in the 1990s has now been extensively studied in recent years to solve the issue presented in the Von Neumann architecture. FIG. 1B illustrates a simplified overview of a computing-in-memory (CIM) architecture 104 utilizing in-memory computing technology. The on-chip memory 105 only supplies the activations to a CIM macro 107 via some buffers 106. Kernel weights are stored within the CIM macro 107. The CIM macro 107 performs the MAC operation. The computation step and memory step can be tightly integrated to reduce the movement of data since only the activations are being moved from the on-chip memory 105.

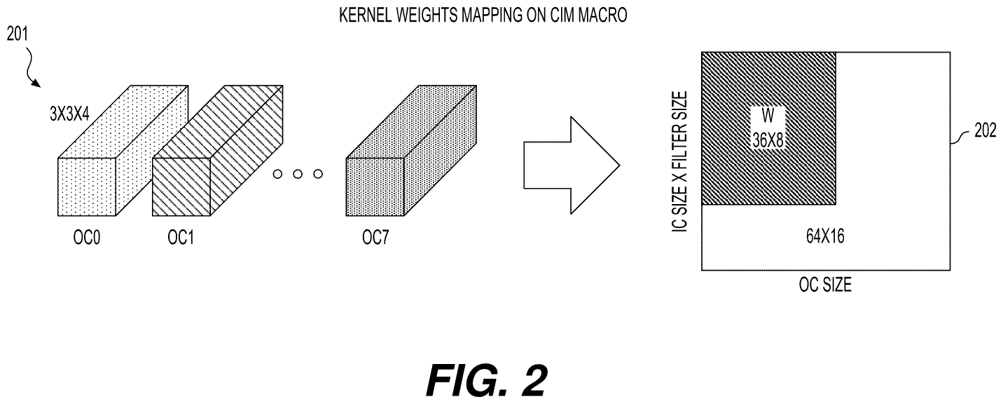

In various applications utilizing computing-in-memory architecture, the CIM macro is used as a computing unit with a fixed dimension. FIG. 2 shows an example of kernel weights 201 mapping onto CIM macro 202. The CIM macro 202 has a fixed dimension of 64×16. The fixed dimension can match with kernel weights having input channel size×filter size=64 and output channel size=16. The output of the CIM macro 202 for each output channel is computed as a summation of products of activation and weight in the output channel:

$$out [ j ] = {\sum }_{i = 0}^{63} A [ i ] \times W [ i \cdot j ] , ∀ j = 0 ∼ 15$$

where A[i] is the activation of the input at the ith row and W[i, j] is the kernel weight of the input at the ith row and the jth column.

However, the kernel weights 201 in the FIG. 2 example have 4 input channels with a 3×3 filter size and 8 output channels, which can be viewed as having a kernel weight shape of 36×8. Mapping the kernel weights 201 onto the CIM macro 202 results in only a portion of the computing units in the CIM macro 202 being utilized. The CIM macro 202 operates the whole circuit for computation regardless of the utilization of each individual computing unit. Therefore, operating a CIM macro when it is not fully mapped has a similar power consumption compared to operating the CIM macro when it is fully mapped.

The current disclosure provides methods and systems for a configurable CIM macro formed with numerous computing units to compute an output from the kernel weights and the activations of an input data mapped onto the computing units. The dimensions of CIM macro can be predetermined. The computing units in the CIM macro can be dynamically configured (turned on or turned off) based on external analysis or mapping arrangement of the system the CIM macro resides in. The CIM macro may be further divided into groups for control signals to turn on or turn off.

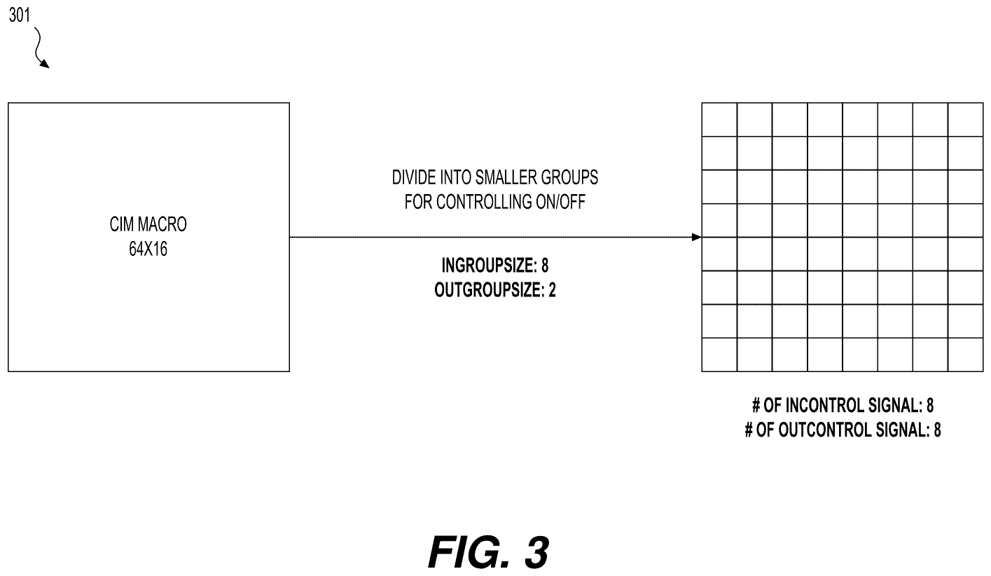

FIG. 3 shows an example of dividing a CIM macro 301 into smaller groups. The CIM macro 301 includes an array of computing units having 64 rows and 16 columns. The 64 rows of computing units are divided into 8 row-groups with indexes of 0˜7. Each row-group includes 8 rows of computing units. The 16 columns of computing units are divided into 8 column-groups with indexes of 0˜7. Each column-group includes 2 columns of computing units. Each row-group of computing units is individually controlled by a control circuit for turning on or off. Each column-group of computing units is individually controlled by a control circuit for turning on or off. The control circuit sends a row-control signal with an index of 0˜7 for each row-group of computing units. The control circuit sends a column-control signal with an index of 0˜7 for each column-group of computing units. By the control circuit, the computing unit in the CIM macro turns on when receiving both the row-control signal and the column-control signal. Depending on the characteristic of the kernel weights and the activations of an input data, the control signal is to turn on or off the row-groups and column-groups of computing units to reduce power consumption. The configuration of the CIM macro described above is only an example. The dimension of active (turned-on) portions of the CIM macro and the sizes of the row-groups and the column groups in the CIM macro can be predetermined or can be dynamically configured for the need of each computation.

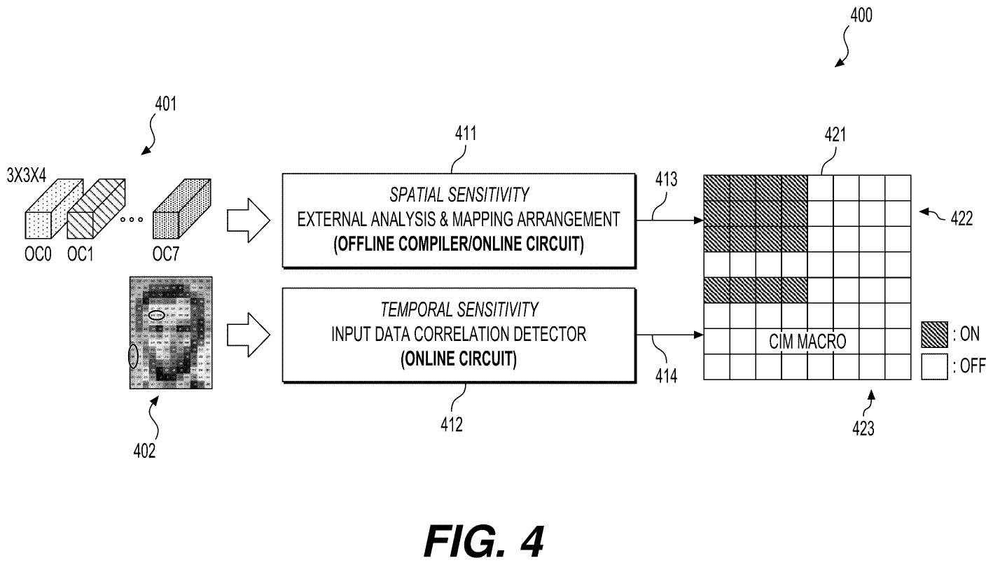

FIG. 4 shows a processing system 400 according to some embodiments of the disclosure. The system 400 can be configured to process neural-network-based applications. The system 400 can include a spatial sensitivity module (411), a temporal sensitivity module (412), and a CIM macro 421. The spatial sensitivity module (411) can also be referred to as an external analysis and mapping arrangement (EAMA) module (411). The spatial sensitivity module (412) can also be referred to as an input data correlation detector (IDCD) module (412).

In an embodiment, the CIM micro 421 can be externally configurable, for example, via control signals (such as control signals 413 and 414) or detection circuits (such as modules 411 and 412), to shut down unused circuits for power reduction. The CIM micro 421 can include an array of computing units. The array of computing units can be organized into row-groups 422 and column-groups 423, in a way similar to that of the FIG. 3 example. The row-groups 422 can each be individually turned on or turned off. The column-groups 423 can each be individually turned on or turned off.

The spatial sensitivity module 411 can be configured to spatially adjust which part of CIM macro 421 is on or off. For example, the EAMA module 411 can receive an input of neural-network parameters 401. For example, the neural-network parameters 401 can include kernel weights (or filter weights) that are organized layer by layer. For each layer of parameters, the EAMA module 411 can analyze the input neural network parameters and determine which row-groups or column-groups to be turned on or turned off. Based on the decision, the EAMA module 411 can generate a set of control signals 413 to turn on or turn off the respective computing units of the CIM micro 421.

In an embodiment, the EAMA module 411 is implemented as an offline compiler. The compiler can perform the analysis of the neural-network parameters 401 in advance of an application being executed on the CIM macro 421. When the application is executed, a control circuit separate from the offline compiler can be employed to generate control signals to control the CIM micro 421. In an embodiment, the EAMA module 411 is implemented as a circuit operating online. For example, the online circuit can analyze the neural-network parameters 401 and determine which part of CIM is on or off in real-time. Based on the decision, the online circuit can generate suitable control signals to turn on or turn off the computing units of the CIM macro. In some examples, an online compiler can be employed. For example, the compiler or a portion of the compiler can operate in real-time to analyze input data and determine how control signals are generated.

The temporal sensitivity module 412 can be configured to temporally adjust which part of CIM macro 421 is on or off. For example, the IDCD module 412 can detect a correlation of input data activations 402. For example, the correlation of the input data activations 402 can include value-based, time-based, or bit-value-based changes in the input data activations 402. The IDCD module 412 can analyze the correlation of input data and determine which row-groups to be turned on or turned off. Based on the decision, the IDCD module 412 can generate a set of control signals 404 to turn on or turn off the respective computing units of the CIM micro 421.

In an embodiment, the IDCD module 412 is implemented as a circuit operating online. For example, the online circuit can analyze the correlation of input data 402 and determine which part of CIM is on or off in real-time. Based on the decision, the online circuit can generate suitable control signals to turn on or turn off the computing units of the CIM macro.

In some embodiments, the IDCD module 412 is implemented separately from the CIM macro. For example, the IDCD module 412 can detect the correlation of input data outside of the CIM macro 421 and generate a set of control signals 404 to turn on or turn off the respective computing units of the CIM micro 421. In some embodiments, the IDCD module 412 is implemented within the CIM macro. For example, the IDCD module 412 can detect the correlation of input data within the CIM macro 421 and generate a set of control signals 404 to turn on or turn off the respective computing units of the CIM micro 421.

According to one aspect of the present disclosure, systems and methods of spatial sensitivity for power reduction utilizing the configurable CIM macro may be done in an offline compiler or in an online circuit. The systems and methods may configure the configurable CIM macro to reduce power by detecting the characteristics of the kernel weight of the input data. The array of computing units in the configurable CIM macro may be divided into smaller groups to allow a fine grained control. Depending on the dimension of the kernel weight shape of the input data, mapping the kernel weights of input data onto the CIM macro may be completed in more than one mapping cycle.

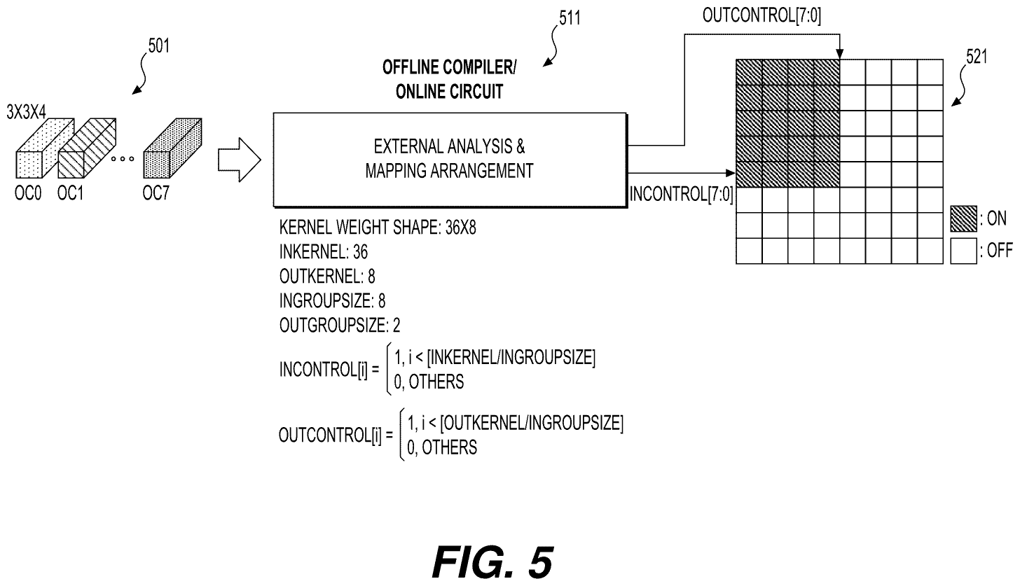

FIG. 5 shows an example of determining control signals based on a weight size of an input data 501 and a dimension of a CIM macro 521. As shown, an EAMA module 511 is coupled with the CIM macro 521. The EAMA module 511 can receive neural-network parameters of the input data 501 which include kernel weights (or filter weights). The kernel weights of the input data 501 have 8 output channels (OCs). Each OC includes kernel weights with a dimension of 3×3×4. Therefore, the input data 501 has a kernel weight shape of 36×8. The CIM macro 521 has a fixed dimension of 64×16 computing units. The 64 rows of computing units are divided into 8 row-groups with indexes of 0˜7. Each row-group includes 8 rows of computing units. The 16 columns of computing units are divided into 8 column-groups with indexes of 0˜7. Each column-group includes 2 columns of computing units. The EAMA module 511 analyzes the received neural-network parameters of the input data 501 and maps the kernel weights of the input data 501 onto the CIM macro 521 according to the analyzed parameters.

In this example, the EAMA module 511 can determine that the kernel weight shape of the input data 501 is smaller than the dimension of the CIM macro 521. The EAMA module 511 maps the kernel weights of the input data 501 onto the first 5 row-groups of computing units and the first 4 column-groups of computing units. The EAMA module 511 can generate a set of control signals to turn on or turn off the respective computing units of the CIM micro 521. For example, the EAMA module 511 can determine the control signals based on the expressions below:

$$InControl [ i ] = \{ \begin{matrix}1 , & i < ⌈ InKernel / InGroupSize ⌉ \\ 0 , & others\end{matrix}$$

$$OutControl [ i ] = \{ \begin{matrix}1 , & i < ⌈ OutKernel / OutGroupSize ⌉ \\ 0 , & others\end{matrix}$$

where InControl[i] denotes a status of a respective control signal corresponding to a respective row-group index i, InKernel denotes the size of the kernel weights corresponding to an OC, InGroupSize denotes the number of the computing units in a row-group, OutControl[i] denotes a status of a respective control signal corresponding to a respective column-group index i, OutKernel denotes the number of OCs, and OutGroupSize denotes the number of computing units in a column-group. With the mapping arrangement shown in FIG. 5, the EAMA module 511 generates the row-control signals with index 0˜4 and sends the row-control signals to the CIM macro 521 to turn on the row-groups with index 0˜4. The EAMA module 511 generates the column-control signals with index 0˜3 and sends column-control signals with index 0˜3 to the CIM macro 521 to turn on the column-groups with index 0˜3. Although the row-group with index 4 which includes 8 rows of computing units is not fully mapped with kernel weights of input data 501, the respective row-control signal is still needed to turn on the row-group with index 4 for the mapped computing units.

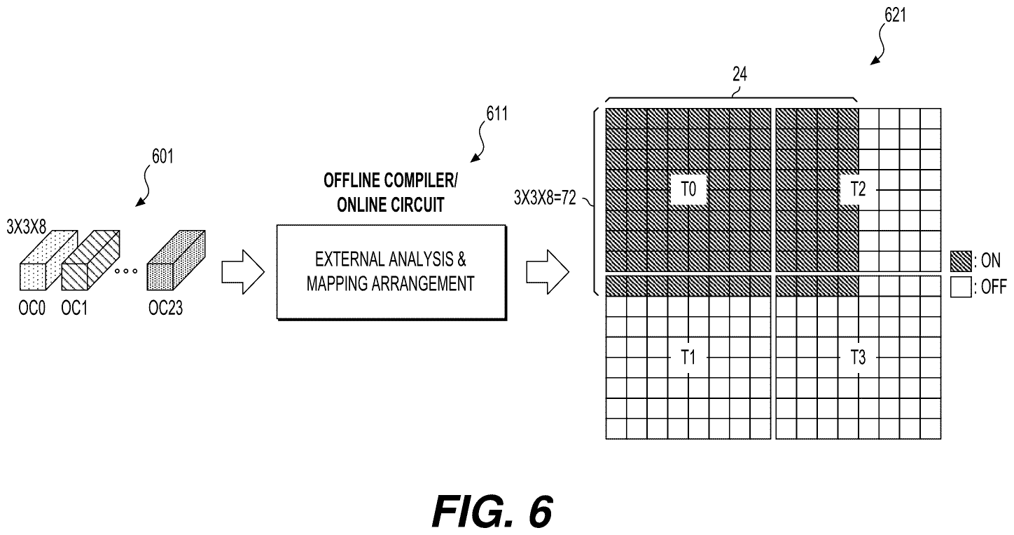

FIG. 6 shows another example of determining control signals based on a weight size of an input data 601 and a dimension of a CIM macro 621. As shown, an EAMA module 611 is coupled with the CIM macro 621. Four cycles of CIM macro 621 are shown. The EAMA module 611 can receive neural-network parameters of the input data 601 which include kernel weights (or filter weights). The kernel weights of the input data 601 have 24 output channels (OCs). Each OC corresponds to kernel weights with a dimension of 3×3×8. Therefore, the input data 601 has a kernel weight shape of 72×24. The CIM macro 621 has the same fixed dimension of 64×16 computing units as the example shown in FIG. 5. The 64 rows of computing units are divided into 8 row-groups with indexes of 0˜7. Each row-group includes 8 rows of computing units. The 16 columns of computing units are divided into 8 column-groups with indexes of 0˜7. Each column-group includes 2 columns of computing units. The kernel weights of the input data 601 can be mapped onto the CIM macro 621 as follows. In a first cycle T0, the first 64 weights of the first 16 OCs are mapped to the 64×16 computing units of the CIM macro 621. In a second cycle T1, the last 8 weights of the first 16 OCs are mapped to the 8×16 computing units of the CIM macro 621. In a third cycle T2, the first 64 weights of the last 8 OCs are mapped to the 64×8 computing units of the CIM macro 621. In a fourth cycle T3, the last 8 weights of the last 8 OCs are mapped to the 8×8 computing units of the CIM macro 621.

The EAMA module 611 analyzes the received neural-network parameters of the input data 601 to determine control signals for configuring the CIM macro 621. In this example, the EAMA module 611 can determine that the kernel weight shape of the input data 601 is larger than the dimension of the CIM macro 621. The EAMA module 611 can generate a set of control signals to turn on or turn off the respective computing units of the CIM micro 621 in each cycle.

With the kernel weight mapping arrangement shown in FIG. 6, in the first cycle TO, the EAMA module 611 generates the row-control signals with index 0˜7 and the column-control signals with index 0˜7. The EAMA module 611 sends the row-control signals with index 0˜7 and the column-control signals with index 0˜7 to the CIM macro 621 to turn on the row-groups with index 0˜7 and the column-groups with index 0˜7, resulting in all computing units are being turned on in the first cycle T0. In the second cycle T1, the EAMA module 611 generates the row-control signal with index 0 and the column-control signals with index 0˜7. The EAMA module 611 sends the row-control signal with index 0 and the column-control signals with index 0˜7 to the CIM macro 621 to turn on the row-group with index 0 and the column-groups with index 0˜7, resulting in only the first row-group of computing units are being turned on in the second cycle T1.

In the third cycle T2, the EAMA module 611 generates the row-control signals with index 0˜7 and the column-control signals with index 0˜3. The EAMA module 611 sends the row-control signals with index 0˜7 and the column-control signals with index 0˜3 to the CIM macro 621 to turn on the row-groups with index 0˜7 and the column-groups with index 0˜3, resulting in the first four column-groups of computing units are being turned on in the third cycle T2. In the fourth cycle T3, the EAMA module 611 generates the row-control signal with index 0 and the column-control signals with index 0˜3. The EAMA module 611 sends the row-control signal with index 0 and the column-control signals with index 0˜3 to the CIM macro 621 to turn on the row-group with index 0 and the column-groups with index 0˜3, resulting in only the first half of the first row-group of computing units are being turned on in the fourth cycle T3.

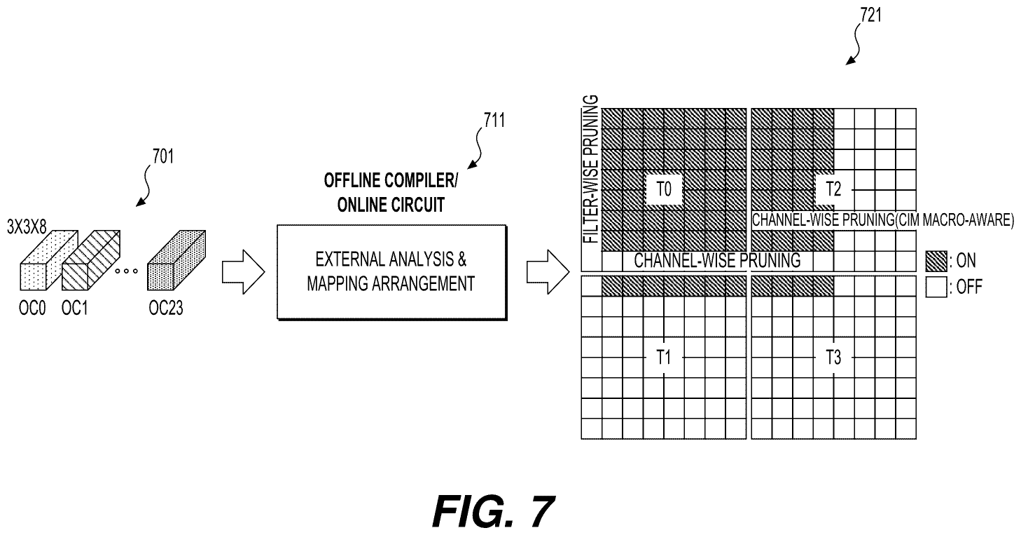

FIG. 7 shows an example of determining control signals based on a weight size of an input data 701 and a dimension of a CIM macro 721 in conjunction with pruning techniques. As shown, an EAMA module 711 is coupled with the CIM macro 721. The EAMA module 711 can receive neural-network parameters of the input data 701 which include kernel weights (or filter weights). Similar to the input data 601 in FIG. 6, the input data 701 has a kernel weight shape of 72×24. The kernel weights of the input data 701 have been pruned using some pruning techniques. The pruned kernel weights of the input data 701 have some zero-valued kernel weights. The EAMA module 711 can determine the kernel weights shape of the input data 701 being larger than the CIM macro 721 and includes zero-valued kernel weights as the result of pruning. In this example, the EAMA module 711 generates control signals similar to the ones described above for FIG. 6, with additional control signals to turn off the computing units where the zero-valued kernel weights are being mapped.

According to another aspect of the current disclosure, systems and methods of temporal sensitivity for power reduction utilizing the configurable CIM macro may be done in an online circuit. The systems and methods may configure the configurable CIM macro to reduce power by detecting the characteristics of the input data. The array of computing units in the configurable CIM macro may be divided into smaller groups to provide a fine grained control. An input data correlation detector (IDCD) detects a correlation of the input data activation resulting from an activation function applied to the input data, and depending on the correlation, the IDCD generates control signals to turn on or off the corresponding computing units in the CIM macro.

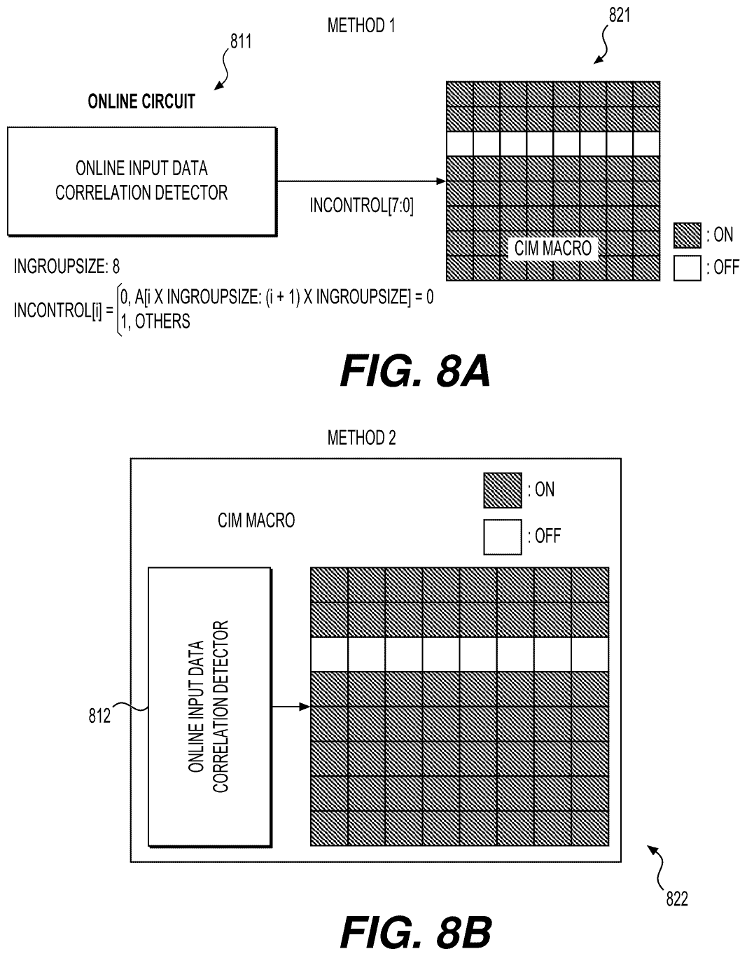

FIG. 8A shows an example of determining control signals based on an activation value of input data activations. As shown, the IDCD 811 is coupled with the CIM macro 821. The IDCD module 811 can receive an activation value of the input data activations. CIM macro 821 has a fixed dimension of 64×16 computing units. The 64 rows of computing units are divided into 8 row-groups with indexes of 0˜7. Each row-group includes 8 rows of computing units. The 16 columns of computing units are divided into 8 column-groups with indexes of 0˜7. Each column-group includes 2 columns of computing units. CIM macro 821 can be configured with latch circuits referred to as activation latches. For example, each column of computing units can correspond to such an activation latch. For each neural network operation, the respective input data activations can be latched to the respective activation latch. The IDCD module 811 detects the correlation of the input data activations and turns on and off the latching operation according to the correlation.

In this example, the IDCD module 811 detects a zero-valued activation for the row-group with index 2. The IDCD module 811 generates a row-control signal with index 2 to turn off the computing units in the CIM macro 821. For example, the IDCD module 811 can determine the control signals based on the expressions below:

$$InControl [ i ] = \{ \begin{matrix}0 , & A [ i \times InGroupSize : ( i + 1 ) \times InGroupSize ] = 0 \\ 1 , & others\end{matrix}$$

where InControl[i] denotes a status of a respective control signal corresponding to a respective row-group index i, A denotes an activation value of an input data activation of the current layer, and InGroupSize denotes the number of the computing units in a row-group. In some embodiments, the IDCD 812 can be integrated within the CIM macro 822 as shown in FIG. 8B.

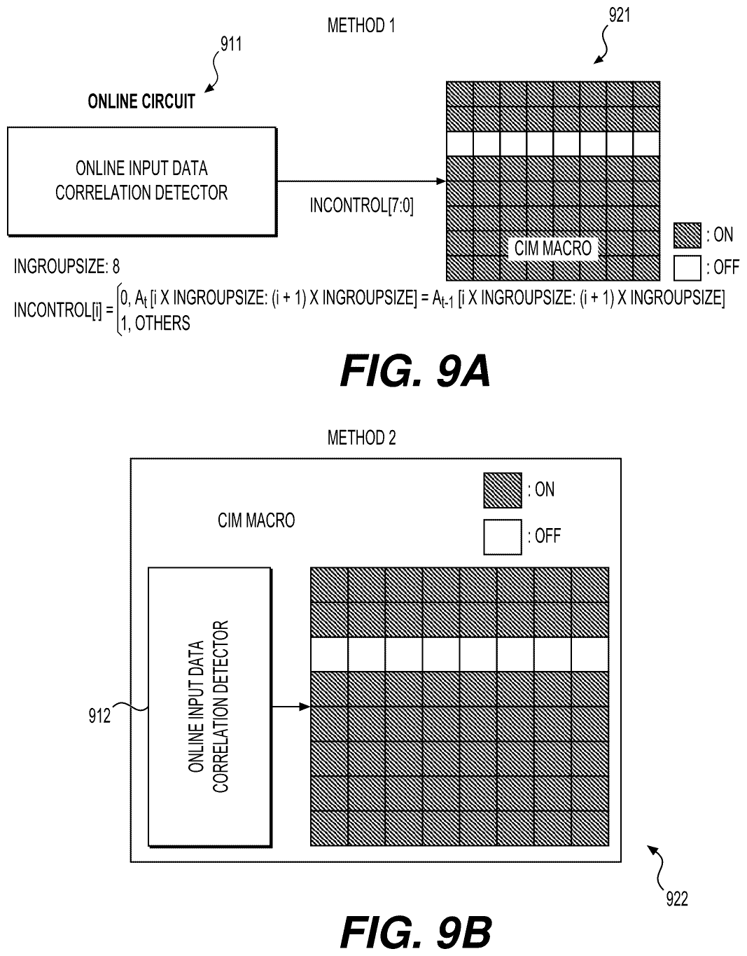

FIG. 9A shows an example of determining control signals based on a change in the activation value of input data activations. As shown, the IDCD 911 is coupled with the CIM macro 921. The IDCD module 911 can receive activation values of the input data activations in each neural network. CIM macro 921 has a fixed dimension of 64×16 computing units. The 64 rows of computing units are divided into 8 row-groups with indexes of 0˜7. Each row-group includes 8 rows of computing units. The 16 columns of computing units are divided into 8 column-groups with indexes of 0˜7. Each column-group includes 2 columns of computing units. CIM macro 921 can be configured with latch circuits referred to as activation latches. For example, each column of computing units can correspond to such an activation latch. For each neural network operation, the respective input data activations can be latched to the respective activation latch. The IDCD module 911 detects the correlation of the input data activations and turns on and off the latching operation according to the correlation.

In this example, the IDCD module 911 detects that the activations for the row-group with index 2 in the current neural network operation have the same values compared to the activations in the last neural network operation. The IDCD module 911 generates a row-control signal with index 2 to turn off the latching operation in the CIM macro 921 in the current neural network operation. In this way, re-latching the same activation values to the respective activation latches can be avoided, lowering the power consumption. For example, the IDCD module 911 can determine the control signals based on the expressions below:

$$InControl [ i ] = \{ \begin{matrix}0 , & {A}_{t} [ i \times InGroupSize : ( i + 1 ) \times InGroupSize ] = \\ & {A}_{t - 1} [ i \times InGroupSize : ( i + 1 ) \times InGroupSize ] \\ 1 , & others\end{matrix}$$

where InControl[i] denotes a status of a respective control signal corresponding to a respective row-group index i, Aₜ denotes an activation value of an input data activation of the current neural network operation, Aₜ₋₁ denotes an activation value of an input data activation of the last neural network operation, and InGroupSize denotes the number of the computing units in a row-group. In some embodiments, the IDCD 912 can be integrated within the CIM macro 922 as shown in FIG. 9B.

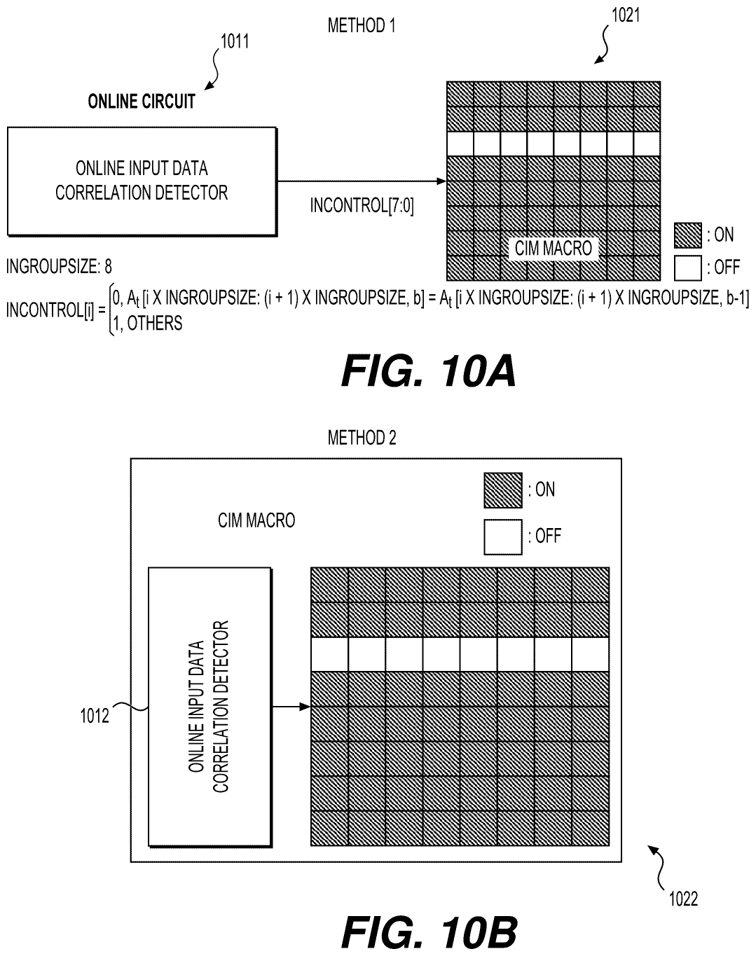

FIG. 10A shows an example of determining control signals based on an activation value of input data activations during a serial execution of a neural network. As shown, the IDCD 1011 is coupled with the CIM macro 1021. The IDCD module 1011 can receive bit values of the input data activations at each bit and maps the activation of each bit onto the CIM macro 1021 in serial. CIM macro 1021 has a fixed dimension of 64×16 computing units. The 64 rows of computing units are divided into 8 row-groups with indexes of 0˜7. Each row-group includes 8 rows of computing units. The 16 columns of computing units are divided into 8 column-groups with indexes of 0˜7. Each column-group includes 2 columns of computing units. The IDCD 1011 detects the correlation of the input data activations and turns on and off the CIM macro 1021 according to the correlation.

In this example, the IDCD module 1011 detects the bit value at the bth bit of an activation has the same bit value at the (b−1)th bit of the activation, where the activation should be mapped to the row-group with index 2. The IDCD module 1011 generates a row-control signal with index 2 to turn off the corresponding computing units in the CIM macro 1021. For example, the IDCD module 1011 can determine the control signals based on the expressions below:

$$InControl [ i ] = \{ \begin{matrix}0 , & {A}_{t} [ i \times InGroupSize : ( i + 1 ) \times InGroupSize , b ] = \\ & {A}_{t} [ i \times InGroupSize : ( i + 1 ) \times InGroupSize , b - 1 ] \\ 1 , & others\end{matrix}$$

where InControl[i] denotes a status of a respective control signal corresponding to a respective row-group index i, Aₜ denotes an activation value of an input data activation of the current neural network operation, b denotes the bth bit of an activation, and InGroupSize denotes the number of the computing units in a row-group. In some embodiments, the IDCD 1012 can be integrated within the CIM macro 1022 as shown in FIG. 10B.

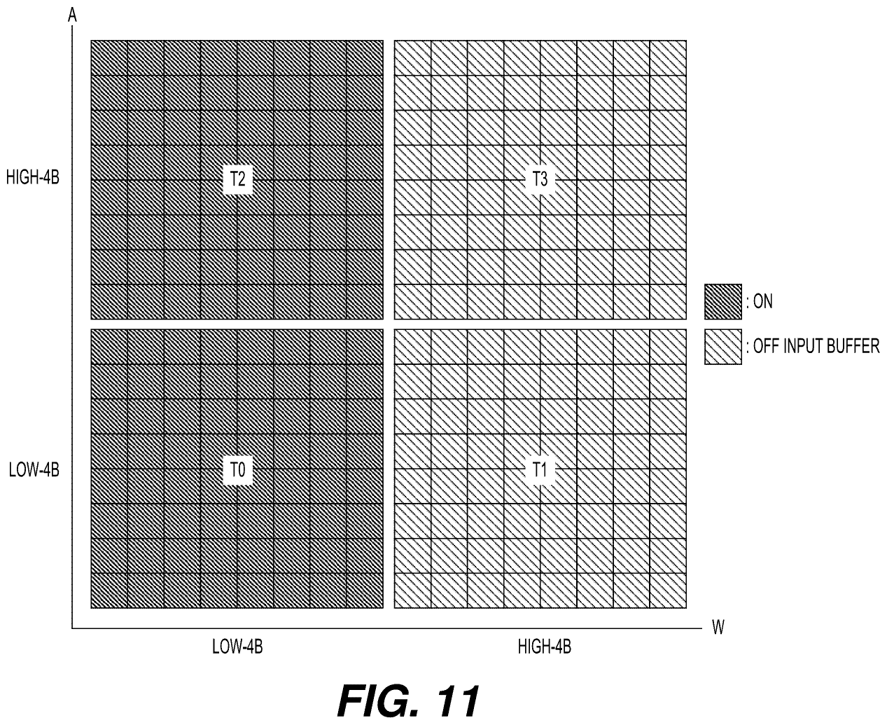

In the event of multiplication of long bit-width activation and long bit-width kernel weight, the multiplication can be composed by dividing the long bit-width into smaller bit-width activation and kernel weight. FIG. 11 shows an example of multiplication between an 8-bit activation and an 8-bit kernel weight. The multiplication is divided into a low 4-bit weight, a high 4-bit weight, a low 4-bit activation, and a high 4-bit activation. Four cycles T0˜T3 of CIM macro are being utilized to compute the multiplication where all computing units have been turned on. Cycle T0 computes the lower 4-bit of weight and the lower 4-bit of activation. Cycle T1 computes the higher 4-bit of weight and the lower 4-bit of activation. Cycle T2 computes the lower 4-bit of weight and the higher 4-bit of activation. Cycle T3 computes the higher 4-bit of weight and the higher 4-bit of activation. In cycle T1, the multiplication uses the same lower 4-bit activation as cycle T0, therefore, the buffer for loading the lower 4-bit activation can be turned off to save power. Similarly, the multiplication in cycle T3 uses the same higher 4-bit activation as cycle T2, therefore, the buffer for loading the higher 4-bit activation can be turned off.

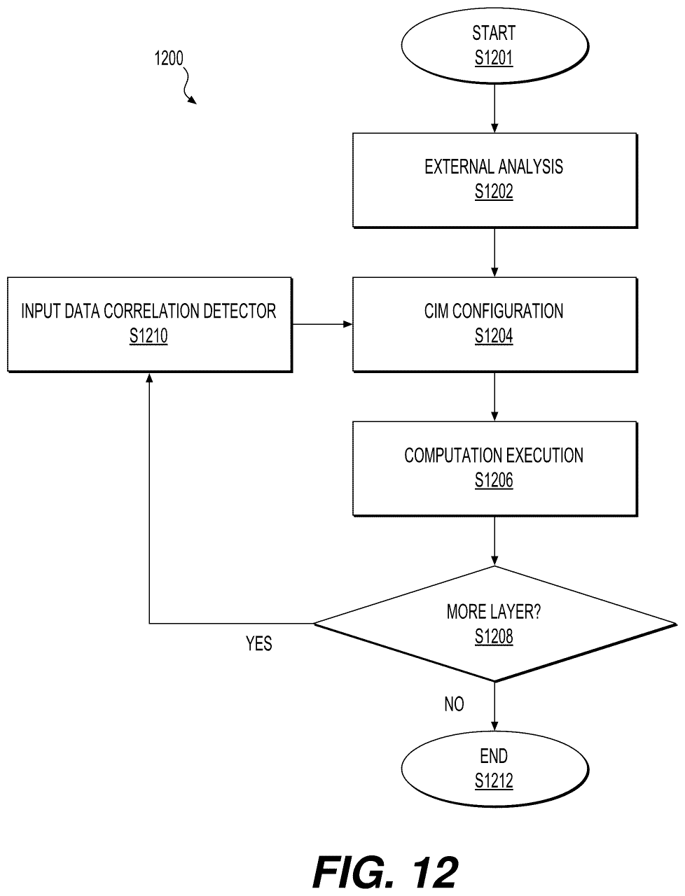

FIG. 12 shows a process 1200 of the configurable CIM macro according to an embodiment of the disclosure. The process 1200 can start from S1201 and proceed to S1202.

At S1202, an external analysis unit analyzes the characteristics of the kernel weights such as dimension, size, and shape of a neural network layer. For example, an input data having 8 OCs with each OC including kernel weights with a dimension of 3×3×4 can be analyzed by the external analysis unit to have a kernel weight shape of 36×8 and is smaller than a CIM macro having a dimension of 64×16 computing units. For example, an input data having 24 OCs with each OC including kernel weights with a dimension of 3×3×8 can be analyzed by the external analysis unit to have a kernel weight shape of 72×24 and is larger than the dimension of the CIM macro having a dimension of 64×16 computing units. For example, an input data having 24 OCs with each OC including kernel weights with a dimension of 3×3×8 which have been pruned by pruning techniques is analyzed by the external analysis unit to have a kernel weight shape of 72×24 with zero-valued kernel weights and is larger than the dimension of the CIM macro having a dimension of 64×16 computing units.

At S1210, an input data correlation detector detects correlations of the input data activations of the neural network operation currently in process 1200. For example, activations can be output from a prior layer and received as input to the current layer in the neural network. For the first layer in the neural network, the original input data is received as the activations. For example, the input data correlation detector can detect zero-valued activations. For example, the input data correlation detector can detect the activation value of an input activation in the current neural network operation is the same compared to the activation value of the input data activation in the last neural network operation. For example, the input data correlation detector can detect the bit value of a bit of an activation is the same compared to the bit value of a pervious bit of the activation during serial execution.

At S1204, a CIM configuration unit configures the CIM macro by turning on or off the computing units in response to the analyzed characteristics of the kernel weights and the detected correlations of the input data activations. For example, the CIM macro can turn off computing units where no kernel weights are being mapped when the kernel weight shape of the input data is smaller than the dimension of the CIM macro. For example, the CIM macro can turn off computing units in multiple cycles where no kernel weights are being mapped when the kernel weight shape of the input data is larger than the dimension of the CIM macro. For example, the CIM macro can turn off computing units in multiple cycles where zero-valued kernel weights are being mapped. For example, the CIM macro can turn off the computing units where a zero-valued activation is being mapped. For example, the CIM macro can turn off latching circuits in the computing units where the activation in the current neural network operation has the same value compared to the activation in the last neural network operation. For example, the CIM macro can turn off latching circuits in the computing units where the bit value at the current bit of an activation has the same value compared to the bit value at the last bit of the activation. The CIM configuration unit turns on or off the computing units can be based on the analyzed characteristics of the kernel weights and the detected correlations of the input data activations at the same time. For example, a computing unit can be turned on according to the analyzed result of the external analysis unit but turned off according to the detected result of the input data correlation detector.

At S1206, the CIM macro executes the computation operation of the current layer with the mapped data.

At S1208, whether there are more neural network layers or operations needed to process is determined. If there are more layers in the neural network, the process 1200 continues to S1210. Otherwise, the process 1200 proceeds to S1212 and terminates at S1212.

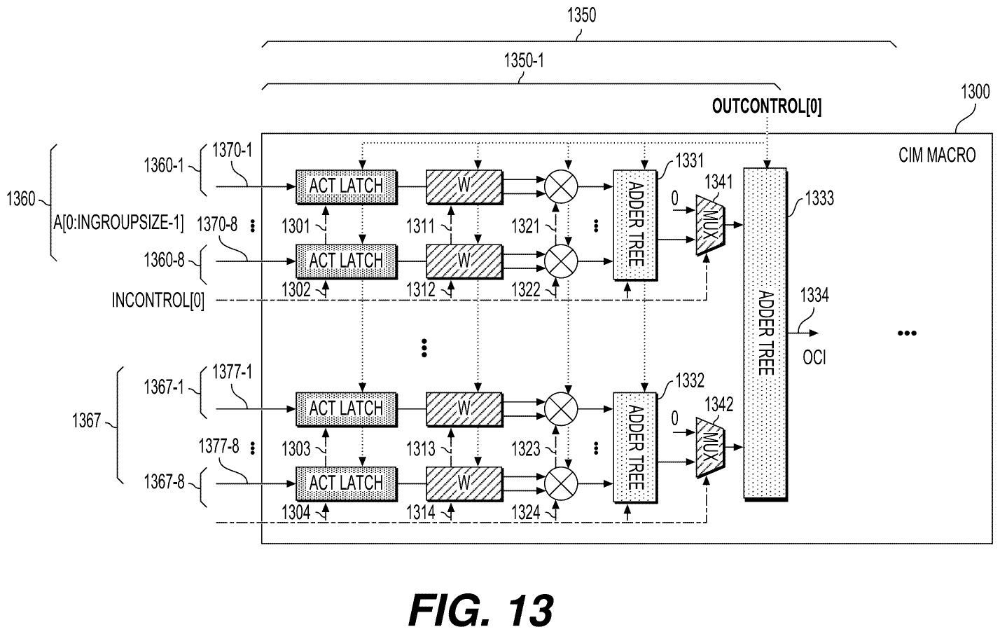

FIG. 13 shows an example of configuring a CIM macro 1300 to save power. The CIM macro 1300 shown in FIG. 13 only includes some elements related to the current disclosure. The CIM macro 1300 may include other elements necessary to complete the neural network computation. As shown, the CIM macro 1300 can include computing units that are grouped into multiple row-groups 1360-1367. For example, the row-group 1360 can include rows (1360-1)-(1360-8). The row-group 1367 can include rows (1367-1)-(1367-8). The computing units are also grouped into multiple column groups, but only the first column-group 1350 is shown. The column-group 1350 can include multiple columns of computing units, but only the first column 1350-1 is shown.

As shown, corresponding to the respective rows and columns, the CIM macro 1300 can include activation latches 1301-1304 for loading activations from external memories, kernel weight buffers 1311-1314 for storing kernel weights within the CIM macro 1300, multipliers 1321-1324, adder trees 1331-1333, and multiplexers 1341, 1342. The elements are interconnected with each other to perform the functions of the CIM macro 1300.

In operation, the CIM macro 1300 can receive activations and perform multiplication and accumulation operations based on the activations and weights stored in the CIM macro 1300. For example, for the computing unit in the first row 1360-1 and the first column 1350-1, the activation latch 1301 can receive and store the activation 1370-1. The weight buffer 1311 can store a kernel weight value. The multiplier 1321 can receive the activation 1370-1 and the kernel weight value and generate a product of the activation 1370-1 and the kernel weight value. Assuming the computing units are all turned on, the products from each computing unit in the first column are added together by going through the adder trees 1331-1333 and the multiplexers 1341-1342. As a result, an output 1334 can be output from the adder tree 1333 corresponding to a first output channel (OC) of the current layer under processing.

The CIM macro 1300 receives one InControl signal for elements in each row-group. For example, an InControl[0] signal is connected with elements in a row-group of computing units to provide controls to each element in the row-group for power reduction. The CIM macro 1300 receives one OutControl signal for elements in each column-group. For example, an OutControl [0] signal is connected with elements in a column-group of computing units to provide controls to each element in the column-group for power reduction.

The InControl[0] can send a control signal to control the latches 1301, 1302 in a row-group from loading the activation into the CIM macro 1300. For example, according to the analysis of an IDCD module, the InControl[0] can send a signal to turn off the latches 1301, 1302 to avoid loading redundant activation. The InControl[0] signal can send an on or off signal to control the read of kernel weights from the kernel weight buffers 1311, 1312 in a row-group. For example, according to the analysis of an EAMA module, the InControl[0] can send a signal to turn off the kernel weight buffers 1311, 1312 from reading the kernel weights. The InControl[0] can send a control signal to control the multipliers 1321, 1322 in a row-group. For example, according to the analysis of an EAMA module or an IDCD module, the InControl[0] can send a signal to turn off the multipliers 1321, 1322 from operating. The InControl[0] can send a control signal to control the adder tree 1331 in the row-group. For example, according to the analysis of an EAMA module or an IDCD module, the InControl[0] can send a signal to turn off the adder tree 1331. The InControl[0] can send a control signal to control the multiplexer 1341 in a row-group. For example, according to the analysis of an EAMA module or an IDCD module, the InControl[0] can send a signal to the multiplexer 1341 to select the default value 0.

The OutControl [0] can send a control signal to control the latches in the column-group from loading the activation into the CIM macro 1300. For example, according to the analysis of an EAMA module, the OutControl [0] can send a signal to turn off the latches 1301-1304 to avoid loading redundant activation. The OutControl [0] signal can send an on or off signal to control the read of kernel weights from the kernel weight buffers 1311-1314 in the column-group. For example, according to the analysis of an EAMA module, the OutControl [0] can send a signal to turn off the kernel weight buffers 1311-1314 from reading the kernel weights. The OutControl [0] can send a control signal to control the multipliers 1321-1324 in the column-group. For example, according to the analysis of an EAMA module, the OutControl [0] can send a signal to turn off the multipliers 1321-1324 in column-group from operating. The OutControl [0] can send a control signal to control the adder trees in the column-group. For example, according to the analysis of an EAMA module, the OutControl [0] can send a signal to turn off the adder trees 1331-1333.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
determining which computing units in a computing-in-memory (CIM) macro are to be turned off, the CIM macro including an array of the computing units with dimensions of X rows and Y columns, the X rows of computing units being organized into N row-groups indexed from 0 to N−1, each row-group including one or more rows of computing units, the Y columns of computing units being organized into M column-groups indexed from 0 to M−1, each column-group including one or more columns of computing units;
based on the determination of which computing units in the CIM macro are to be turned off, turning off at least one row-group of computing units or at least one column-group of computing units, each row-group of computing units being separately controllable to be turned off, each column-group of computing units being separately controllable to be turned off; and
performing a computation based on kernel weights and activations of a neural network stored in the active computing units in the CIM macro that are not turned off.

2. The method of claim 1, wherein the determining which computing units in a computing-in-memory (CIM) macro are to be turned off comprises:
determining a number of output channels (OCs) in a layer of the neural network;
determining a number of kernel weights corresponding to each OC, the kernel weights corresponding to each OC being to be mapped to a respective one of the Y columns of computing units;
in response to the number of OCs being smaller than Y, determining to turn off the column-groups of computing units to which no kernel weights are to be mapped; and
in response to the number of kernel weights corresponding to each OC being smaller than X, determining to turn off the row-groups of computing units to which no kernel weights are to be mapped.

3. The method of claim 1, wherein the determining which computing units in a computing-in-memory (CIM) macro are to be turned off comprises:
determining a number of output channels (OCs) in a layer of the neural network;
determining a number of kernel weights corresponding to each OC, the kernel weights corresponding to each OC being to be mapped to a respective one of the Y columns of computing units;
in response to the number of OCs being larger than Y, determining to turn off the column-groups of computing units to which no kernel weights are to be mapped during sequential computing cycles; and
in response to the number of kernel weights corresponding to each OC being larger than X, determining to turn off the row-groups of computing units to which no kernel weights are to be mapped during sequential computing cycles.

4. The method of claim 1, wherein the determining which computing units in a computing-in-memory (CIM) macro are to be turned off comprises:
determining a number of output channels (OCs) in a layer of the neural network;
determining a number of kernel weights corresponding to each OC, the kernel weights corresponding to each OC being to be mapped to a respective one of the Y columns of computing units;
in response to the number of OCs wherein all kernel weights in one OC being zero, determining to turn off the column-groups of computing units to which the kernel weights are to be mapped during sequential computing cycles; and
in response to the kernel weights corresponding to each OC being zero, determining to turn off the row-groups of computing units to which no kernel weights are to be mapped.

5. The method of claim 1, wherein the determining which computing units in a computing-in-memory (CIM) macro are to be turned off comprises:
receiving a number of activations shared by a number of output channels (OCs) in a layer of the neural network, the activations shared by the OCs being to be mapped to respective ones of the Y columns of computing units;
among the number of activations shared by the number of OCs, determining the activations corresponding to the at least one row-group of computing units being zero; and
determining to turn off the at least one row-group of computing units.

6. The method of claim 1, further comprising:
latching first activations to a first row-group of computing units at time t for a first neural network operation;
determining whether second activations to be latched to the first row-group of computing units at time t+1 for a second neural network operation are the same as the first activations; and
in response the second activations to be latched to the first row-group of computing units at time t+1 for the second neural network operation are the same as the first activations, determining not to re-latch the second activations to the first row-group of computing units.

7. The method of claim 1, wherein the determining which computing units in a computing-in-memory (CIM) macro are to be turned off comprises:
receiving a number of activations shared by a number of OCs in a layer of the neural network, the activations shared by the OCs being to be mapped to respective ones of the Y columns of computing units and each including first bit position and second bit position neighboring each other;
performing first multiplications based on first bit values corresponding to the first bit positions of the activations shared by the OCs in the array of the computing units;
determining, corresponding to the at least one row-group of computing units, second bit values corresponding to the second bit positions and the first bit values corresponding to the first bit positions of the activations being the same; and
in response to, corresponding to the at least one row-group of computing units, second bit values corresponding to the second bit positions and the first bit values corresponding to the first bit positions of the activations being the same, determining to turn off the at least one row-group of computing units for performing second multiplications based on the second bit values corresponding to the second bit positions of the activations shared by the OCs in the array of the computing units.

8. The method of claim 1, wherein the performing a computation based on kernel weights and activations of a neural network stored in the active computing units in the CIM macro that are not turned off comprises:
dividing a long bit-width activation into smaller bit-width activations;
dividing a long bit-width kernel weight into smaller bit-width kernel weights;
in response to compute with lower bit-width activations, determining to turn off input buffers for the higher bit-width kernel weights; and
in response to compute with higher bit-width activations, determining to turn off input buffers for the higher bit-width kernel weights.

9. An apparatus, comprising circuitry configured to:
determine which computing units in a computing-in-memory (CIM) macro are to be turned off, the CIM macro including an array of the computing units with dimensions of X rows and Y columns, the X rows of computing units being organized into N row-groups indexed from 0 to N−1, each row-group including one or more rows of computing units, the Y columns of computing units being organized into M column-groups indexed from 0 to M−1, each column-group including one or more columns of computing units;
based on the determination of which computing units in the CIM macro are to be turned off, turn off at least one row-group of computing units or at least one column-group of computing units, each row-group of computing units being separately controllable to be turned off, each column-group of computing units being separately controllable to be turned off; and
perform a computation based on kernel weights and activations of a neural network stored in the active computing units in the CIM macro that are not turned off.

10. The apparatus of claim 9, wherein the circuitry is further configured to:
determine a number of output channels (OCs) in a layer of the neural network;
determine a number of kernel weights corresponding to each OC, the kernel weights corresponding to each OC being to be mapped to a respective one of the Y columns of computing units;
in response to the number of OCs being smaller than Y, determine to turn off the column-groups of computing units to which no kernel weights are to be mapped; and
in response to the number of kernel weights corresponding to each OC being smaller than X, determine to turn off the row-groups of computing units to which no kernel weights are to be mapped.

11. The apparatus of claim 9, wherein the circuitry is further configured to:
determine a number of output channels (OCs) in a layer of the neural network;
determine a number of kernel weights corresponding to each OC, the kernel weights corresponding to each OC being to be mapped to a respective one of the Y columns of computing units;
in response to the number of OCs being larger than Y, determine to turn off the column-groups of computing units to which no kernel weights are to be mapped during sequential computing cycles; and
in response to the number of kernel weights corresponding to each OC being larger than X, determine to turn off the row-groups of computing units to which no kernel weights are to be mapped during sequential computing cycles.

12. The apparatus of claim 9, wherein the circuitry is further configured to:
determine a number of output channels (OCs) in a layer of the neural network;
determine a number of kernel weights corresponding to each OC, the kernel weights corresponding to each OC being to be mapped to a respective one of the Y columns of computing units;
in response to the number of OCs wherein all kernel weights in one OC being zero, determine to turn off the column-groups of computing units to which the kernel weights are to be mapped during sequential computing cycles; and
in response to the kernel weights corresponding to each OC being zero, determine to turn off the row-groups of computing units to which no kernel weights are to be mapped.

13. The apparatus of claim 9, wherein the circuitry is further configured to:
receive a number of activations shared by a number of output channels (OCs) in a layer of the neural network, the activations shared by the OCs being to be mapped to respective ones of the Y columns of computing units;
among the number of activations shared by the number of OCs, determine the activations corresponding to the at least one row-group of computing units being zero, and
determine to turn off the at least one row-group of computing units.

14. The apparatus of claim 9, wherein the circuitry is further configured to:
latch first activations to a first row-group of computing units at time t for a first neural network operation;
determine whether second activations to be latched to the first row-group of computing units at time t+1 for a second neural network operation are the same as the first activations; and
in response the second activations to be latched to the first row-group of computing units at time t+1 for the second neural network operation are the same as the first activations, determine not to re-latch the second activations to the first row-group of computing units.

15. The apparatus of claim 9, wherein the circuitry is further configured to:
receive a number of activations shared by a number of OCs in a layer of the neural network, the activations shared by the OCs being to be mapped to respective ones of the Y columns of computing units and each including first bit position and second bit position neighboring each other;
perform first multiplications based on first bit values corresponding to the first bit positions of the activations shared by the OCs in the array of the computing units;
determine, corresponding to the at least one row-group of computing units, second bit values corresponding to the second bit positions and the first bit values corresponding to the first bit positions of the activations being the same; and
in response to, corresponding to the at least one row-group of computing units, second bit values corresponding to the second bit positions and the first bit values corresponding to the first bit positions of the activations being the same, determine to turn off the at least one row-group of computing units for performing second multiplications based on the second bit values corresponding to the second bit positions of the activations shared by the OCs in the array of the computing units.

16. The apparatus of claim 9, wherein the circuitry is further configured to:
divide a long bit-width activation into smaller bit-width activations;
divide a long bit-width kernel weight into smaller bit-width kernel weights;
in response to compute with lower bit-width activations, determine to turn off input buffers for the higher bit-width kernel weights; and
in response to compute with higher bit-width activations, determine to turn off input buffers for the higher bit-width kernel weights.

17. A non-transitory computer-readable medium storing instructions that, when executed by a processor, cause the processor to perform a method, the method comprising:
determining which computing units in a computing-in-memory (CIM) macro are to be turned off, the CIM macro including an array of the computing units with dimensions of X rows and Y columns, the X rows of computing units being organized into N row-groups indexed from 0 to N−1, each row-group including one or more rows of computing units, the Y columns of computing units being organized into M column-groups indexed from 0 to M−1, each column-group including one or more columns of computing units;
based on the determination of which computing units in the CIM macro are to be turned off, turning off at least one row-group of computing units or at least one column-group of computing units, each row-group of computing units being separately controllable to be turned off, each column-group of computing units being separately controllable to be turned off; and
performing a computation based on kernel weights and activations of a neural network stored in the active computing units in the CIM macro that are not turned off.

18. The non-transitory computer-readable medium of claim 17, wherein the method further comprises:
determining a number of output channels (OCs) in a layer of the neural network;
determining a number of kernel weights corresponding to each OC, the kernel weights corresponding to each OC being to be mapped to a respective one of the Y columns of computing units;
in response to the number of OCs being smaller than Y, determining to turn off the column-groups of computing units to which no kernel weights are to be mapped; and
in response to the number of kernel weights corresponding to each OC being smaller than X, determining to turn off the row-groups of computing units to which no kernel weights are to be mapped.

19. The non-transitory computer-readable medium of claim 17, wherein the method further comprises:
determining a number of output channels (OCs) in a layer of the neural network;
determining a number of kernel weights corresponding to each OC, the kernel weights corresponding to each OC being to be mapped to a respective one of the Y columns of computing units;
in response to the number of OCs being larger than Y, determining to turn off the column-groups of computing units to which no kernel weights are to be mapped during sequential computing cycles; and
in response to the number of kernel weights corresponding to each OC being larger than X, determining to turn off the row-groups of computing units to which no kernel weights are to be mapped during sequential computing cycles.

20. The non-transitory computer-readable medium of claim 17, wherein the method further comprises:
determining a number of output channels (OCs) in a layer of the neural network;
determining a number of activations corresponding to each OC, the activations corresponding to each OC being to be mapped to a respective one of the Y columns of computing units; and
in response to the activation corresponding to each OC being zero, determining to turn off the row-groups of computing units to which no activations are to be mapped.
